(19) United States
(12) Patent Application Publication
(10) Pub. No.: US 2005/0097128 A1
(43) Pub. Date: May 5, 2005

(54) Method for scalable, fast normalization of XML documents for insertion of data into a relational database

(76) Inventors: Joseph David Ryan, Campbell, CA (US); Hovey Raymond Strong JR., San Jose, CA (US); Chung-Hao Tan, San Jose, CA (US)

Correspondence Address: Frederick W. Gibb, III;McGinn & Gibb, PLLC, Suite 304, 2568-A Riva Road, Annapolis, MD, 21401, US

(21) Appl. No.: 10/699,203

(22) Filed: Oct. 31, 2003

(51) Int. Cl. G06F 17/00

(52) U.S. Cl. 707/103 Y

(57) ABSTRACT

Disclosed is a method of transferring data from a hierarchical file (having a hierarchical structure, e.g., a markup language file) to a relational database structure (made up of columns and rows. Before processing the actual data, the invention first partitions the hierarchical structure into sections, where each section is dedicated to at least one node of the hierarchical structure. The partitioning process is based on the document type definition file, which is separate from, and different than the hierarchical file. After completing the partitioning, the invention then parses the actual data contained in the hierarchical data file to produce a stream of data pairs and end of section indicators. During the data parsing process, the invention loads the data pairs into corresponding “sections” (created prior to the parsing process) as the data pairs are output from the parsing process. The invention also transfers the node data from these sections to the columns and rows of the relational database structure.

### BACKGROUND OF THE INVENTION

1. Field of the Invention

The present invention generally relates to data conversion and processing for loading data into relational databases, and more specifically to loading hierarchally organized data into relational databases.

2. Description of the Related Art

Loading data from markup language documents into relational databases is sometimes referred to as “shredding.” This process is described in U.S. Patent Publication 2002/0112224 to Cox (hereinafter “Cox”), which is incorporated herein by reference. Cox explains that markup languages for describing data and documents are well-known within the art, especially Hyper Text Markup Language (“HTML”). Another well-known markup language is Extensible Markup Language (“XML”). Both of these languages have many characteristics in common. Markup language documents tend to use tags which bracket information within the document. For example, the title of the document may be bracketed by a tag <TITLE> followed by the actual text of the title for the document, closed by a closing tag for the title such as </TITLE>.

Hypertext documents, such as HTML, are primarily used to control the presentation of a document, or the visual rendering of that document, such as in a web browser. As such, many of the tags which are defined in the HTML standards control the visual appearance of the presentation of the data or information within the document, such as text, tables, buttons and graphics.

XML is also a markup language, but it is intended primarily not for visual presentation of documents but for data communications between peer computers. For example, an XML document may be used to transmit catalog information from one server computer to another server computer so that the receiving server computer can load that data into a database. While XML documents maybe viewed or presented, the primary characteristics of the XML language provide for standardized interpretation of the data which is included, rather than standardized presentation of the data which is included in the document.

As such, XML is a highly flexible method or definition which allows common information formats to be shared both across computer networks such as the World Wide Web, and across intranets. This standard method of describing data allows users and computers to send intelligent “agents” or programs to other computers to retrieve data from those other computers. For example, an intelligent agent could be transmitted from a user's web browser or application server system to a plurality of database servers to gather certain information from those servers and return it. Because XML provides a method for the intelligent agent to interpret the data within the XML document, the agent can then execute its function according to the parameters specified by the user of the intelligent agent.

XML is “extensible” because the markup symbols, or “tags”, are not limited to a predefined set, but rather are self-defining through a companion file or document called a Document Type Definition (“DTD”). As such, additional document data items may be defined by adding them to the appropriate DTD for a class of XML files, thereby “extending” the definition of the class of XML files. XML is actually a reduced set of the Standard Generalized Markup Language (“SGML”) standard. The DTD file associated with a particular class of XML documents describes to an XML reader or XML compiler how to interpret the data which is contained within the XML document.

For example, a DTD file may define the contents of an XML document (or class of documents) which are catalog page listings for computer products. In this example, the DTD document may describe an element “computer specifications.” Within that element may be several data items which are bracketed by tags, such as<MODEL> and </MODEL>, <PART_NUMBER> and </PART_NUMBER>, <DESCRIPTION> and </DESCRIPTION>, <PROCESSOR> and </PROCESSOR>, <MEMORY> and </MEMORY>, <OPERATING_SYSTEM> and <OPERATING_SYSTEM>, etc. Thus, the DTD document defines a set or group of data items which are surrounded by markup tags or symbols for that particular class of XML documents, and it serves as a “key” for other programs to interpret and extract the data from XML documents in that class.

As in this example, an XML reader could be used to view the XML files, interpreting and presenting visually the contents of the XML files somewhat like a catalog page, and according to the DTD definitions. Unlike an HTML document, however, the XML document may be used for more data intensive or data communications related purposes. For example, an XML compiler can be used to parse and interpret the data within the document, and to load the data into yet another document or into a database. Also, as described earlier, an intelligent agent program may be dispatched to multiple server computers on a computer network looking for XML documents containing certain data, such as computers with a certain processor and memory configuration. That intelligent agent then can report back to its origin the XML documents that it has found. This would enable a user to dispatch the intelligent agent to gather and compile XML documents which describe a computer the user may be looking to buy. One common business application of XML is to use it as a common data format for transfer of data from one computer to another, or from one database to another database.

There are several tradeoffs with current XML implementations: performance, ease of use, and extendibility. Typically, performance is inversely related to ease of use, and often, extendibility is not an option. When loading data from an XML document into a database, the following steps typically occur by systems available currently:
(a) parsing of the XML file, which loads all the data contained in the XML file into system memory for use by the program;
(b) generating of database commands, such as SQL statements, to execute against the database to load the data from the XML file into the database; and
(c) establishing communications to or a session with a database or database server, and
(d) issuing the appropriate database commands to accomplish the data loading.

Turning to FIG. 1A, the well-known process of loading an XML document into a database is shown. First, the entire XML document is loaded (1) into system memory (2). As some XML documents are quite large, and several documents may be being loaded simultaneously by one computer, this can present a considerable demand on system memory resources. Then, the entire XML file is parsed (3) for specific elements and data items according to the DTD file. This, too, tends to consume considerable system memory resources because XML files can be very large files. The most common parsing technology used in this step is referred to as “DOM.” DOM is a process which loads an entire XML file into memory and then processes it until complete.

Next, after all the data items and elements have been parsed from the XML file, SQL commands (or other database API commands) are generated (4) in order to accomplish the data loading into a database. Last, the SQL commands are executed (5) in order to affect the loading of the data from the XML document into the database. Subsequently, any further XML documents to be parsed and loaded into the database are retrieved and processed one document at a time (6).

The system in Cox improved upon prior systems by parsing the markup language data into elements which are then simultaneously processed through an SQL command generator in parallel. FIG. 1B shows the improvement made in Cox where XML files are received via file transfer protocol through an FTP receptor (41). Alternatively, these files could be loaded onto the system using computer-readable media, or through another suitable network file transmission scheme. A thread of the SAX XML parser (42) is instantiated to process the recently received XML file into XML elements. The Operator class (44) is called for each XML element to be processed. The Operator class is used to store the attributes and child elements for the registered elements. This class returns the vector of SQL statements it generates, which are later used to update the database according to the XML data.

The Operator class (44) may have one or more operator plugins (45) which provide code specific for parsing XML elements for specific XML document types according to their DTD files, and for generating appropriate database API commands for those data elements. For example, one operator plugin may be provided to generate SQL commands for XML computer parts catalog pages. Another operator plugin may be provided to generate SQL commands for computer software specifications. Each plugin is called according to an XML document's DTD.

The Operator (44) generates database API commands, preferably SQL commands, in response to examination of the XML elements from the XML parser (42). The vector full of SQL commands is placed into an SQL Queue (46) for reception by the SQL processor threads (47), which execute the SQL commands. The SQL Processor threads (47) may retrieve the queued SQL commands as they are ready for additional commands to execute in real-time. By executing the queued SQL commands the SQL Processor threads (47) update the database (48).

The system in Cox improved upon prior systems by parsing the markup language data into elements which are then simultaneously processed through an SQL command generator in parallel. This system in FIG. 2 shows the timeline associated with the completion of loading an XML file into the database according to the invention in Cox. As can be seen from this figure, many of the processes run in parallel and are decoupled from each other via the queues. The parsing of the XML into elements (51) yields an element almost immediately after the beginning of the process by using the SAX method. Thus, when the first element is found and parsed, it is available for the SQL command generator to receive. Then, as the generation of the SQL (53) yields the first SQL command to be executed, the SQL command is placed in the SQL command queue (54). This SQL command will immediately fall through the empty queue on the first entry, and will be received by the waiting SQL execution thread where it will then be executed (55).

While the invention provided in Cox is a substantial improvement over conventional systems, the invention builds upon the achievements reached by Cox by performing various pre-processing steps before processing the markup language data stream (or any hierarchical data) so as to reduce the number of SQL statements, decrease memory requirements, and increase processing speed.

### SUMMARY OF THE INVENTION

The invention comprises a method of transferring data from a hierarchical file (having a hierarchical data structure, e.g., a markup language file) to a relational database structure (made up of columns and rows). To accomplish this, before processing the actual data, the invention first partitions the hierarchical data structure into sections, where each section is dedicated to at least one node of the hierarchical data structure. The partitioning process is based on the hierarchical data structure, which is separate from, and different than the hierarchical file. For example, the document type definition file holds the hierarchical data structure of the markup language file, not the data itself. The set of leaf nodes of the hierarchical data structure, ordered in the order encountered in a depth first search of the structure, is called the “frontier.” A depth first search starts at the root and progresses down the tree, one branch at a time, always going as far down the tree as possible, before moving to the next branch. The hierarchical data structure includes repeating nodes. The partitioning process creates a “section” comprising a set of temporary memory locations for each maximally contiguous (on the frontier) set of leaf nodes with the same pattern.

After completing the partitioning, the invention then parses the actual data contained in the hierarchical data file to produce a stream of data pairs and end of section indicators. The data pairs are only the leaf nodes of the hierarchical file. The parsing process relocates the position of all data in the hierarchical file to the leaf nodes of the hierarchical file corresponding to leaf nodes of the hierarchical data structure. Each of the data pairs is in the form (tag, field). The “field” represents leaf node data and the “tag” represents the location of the corresponding leaf node within the hierarchical data structure.

During the data parsing process, the invention loads each field into a temporary memory location in the section to which the tag belongs. The invention also transfers the node data from these sections to the columns and rows of the relational database structure. Node data is transferred from the sections to the relational database when an end of section indicator is encountered. The data in a section is erased only when, after its end of section indicator is encountered, a new corresponding data pair (tag and field) is produced by the parsing process and the tag belongs to the section.

### BRIEF DESCRIPTION OF THE DRAWINGS

The invention will be better understood from the following detailed description with reference to the drawings, in which:

FIGS. 1A and 1B are schematic diagrams illustrating a method of loading an XML document into a database;

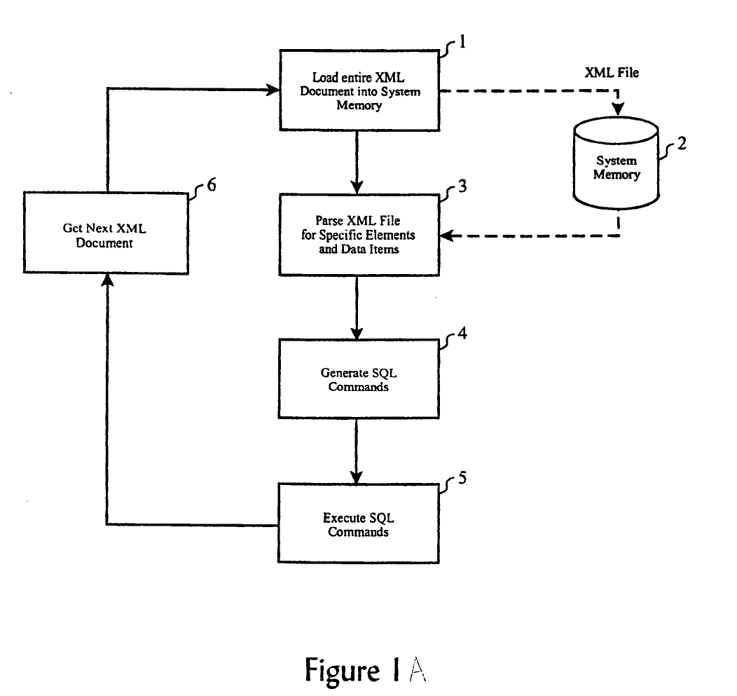

FIG. 2 is a schematic diagram illustrating the timing of an improved method of loading an XML document into a database;

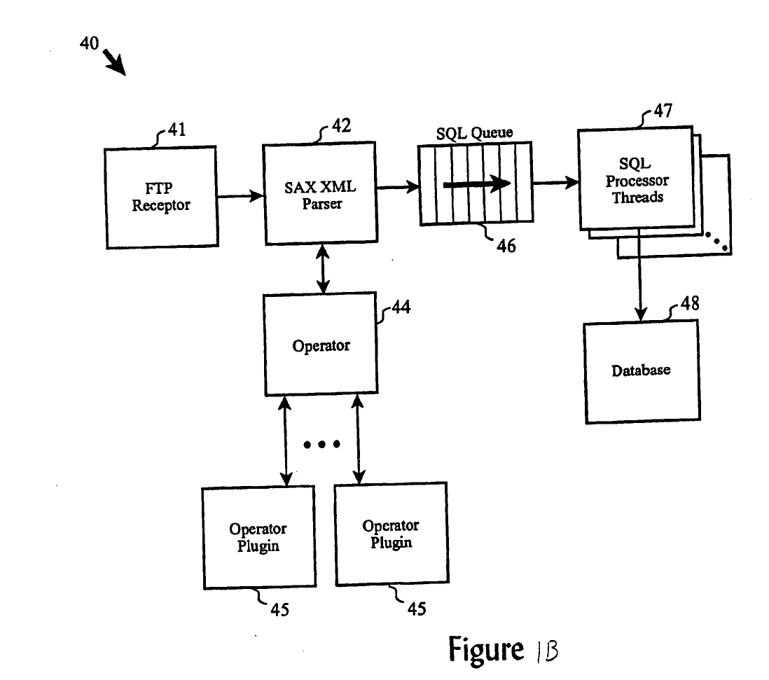

FIGS. 3A and 3B are schematic diagrams illustrating a hierarchical data structure having a root node, branch nodes, and leaf nodes, some nodes being repeating nodes;

FIGS. 4A and 4B are schematic diagrams illustrating the sections created with the invention;

FIG. 5 is a schematic diagram illustrating a hierarchical data design having a root node, branch nodes, and leaf nodes;

FIG. 6 is a schematic diagram illustrating tables within a relational database;

FIG. 7 is a flowchart illustrating one aspect of the invention;

FIG. 8 is a flowchart illustrating one aspect of the invention.

### DETAILED DESCRIPTION OF PREFERRED EMBODIMENTS OF THE INVENTION

The present invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the present invention in detail. The examples used herein are intended merely to facilitate an understanding of ways in which the invention may be practiced and to further enable those of skill in the art to practice the invention. Accordingly, the examples should not be construed as limiting the scope of the invention.

There are many known methods for moving data from XML documents into relational databases, such as the Cox example discussed above. Some methods encounter performance problems when the documents are either very large or arrive too rapidly for processing. The present invention solves scalability (size of document) and performance problems by operating on each document as if it were one of many potentially infinite streams of XML data, using a SAX or other parser that produces a stream of XML events rather than a completed parse tree.

The invention applies a DTD based state machine to the event stream to transform small contiguous sections of XML into ordered lists of data ready for database insertion via previously prepared SQL statements associated with individual database tables. There are several novel aspects of the invention. For example, the invention organizes the XML DTD into sections that each correspond to one or more small contiguous sections of the XML document. The invention also generates one SQL statement per “section” of the XML document versus the generation of an SQL statement for each data element in, for example, the Cox invention. Further, the invention retains data in sections until the section is needed for new data rather than removing the data from the section when it is sent for SQL processing. This makes the data available for subsequent SQL processing of data from related sections, capturing hierarchical relationship information for the database. With appropriate throttling to match the maximum throughput of the database, the invention could run on an infinite stream of XML data without ever increasing its memory requirement, which is a function of the DTD, not the document.

The invention provides further efficiency in the process of data loading (also known as “shredding”). In particular, the invention provides pre-processing steps and data grouping steps that reduce the number of SQL commands issued by the data loader from what would be the result of a straightforward implementation of the Cox invention. This invention produces appropriate inserts and updates in a relational database corresponding to the stream of data. Prerequisites for applying the method steps of the invention to a data stream are a tree with repeating nodes and a set of rules that map nodes of the tree to database columns.

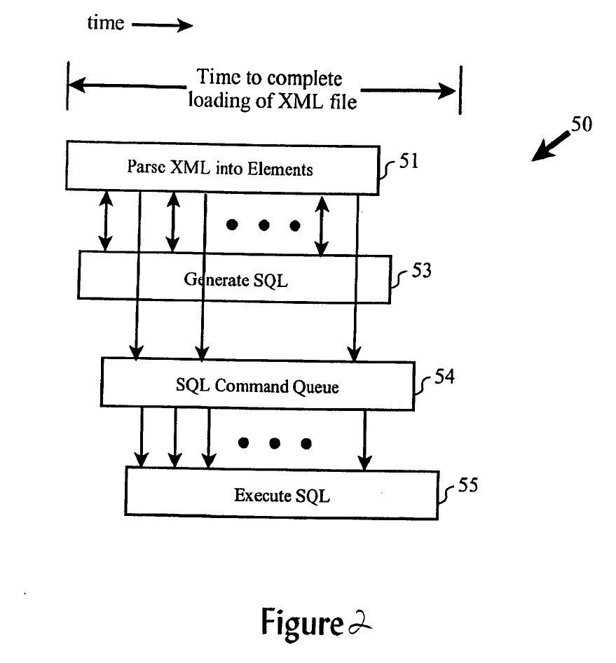

With respect to some terms used herein, “normalizing” is a technical term meaning reorganizing the data so that it fits into a relational database. It comes from the various “normal” forms for relational data. In a relational database, the data is organized into tables consisting of rows and columns. When data is hierarchically organized, it is organized as a tree with repeating nodes (as shown, for example, in FIGS. 3A and 3B). In each case, the organization carries information about the relationships between the individual data values. The process of normalization is the process of capturing the information implicit in one organization within the tabular structure of relational data organization. When the invention normalizes XML data, this process is called shredding.

Markup language tags represent named positions in the hierarchical structure. The values are the data values at the leaves of the hierarchical (tree with repeating nodes) structure. XML uses tags in the form <name> and the form </name> among others. When the invention converts an XML stream into a stream of pairs consisting of a tag and a field (value), the invention accumulates “begin” tags of the form <name> until the invention encounter a data value sitting between a begin and an end tag as <name>value</name>. Then, the invention records a unique representation of the position (the string of begin tags encountered between the root of the tree and the data value) as the tag to be sent out with the field (value).

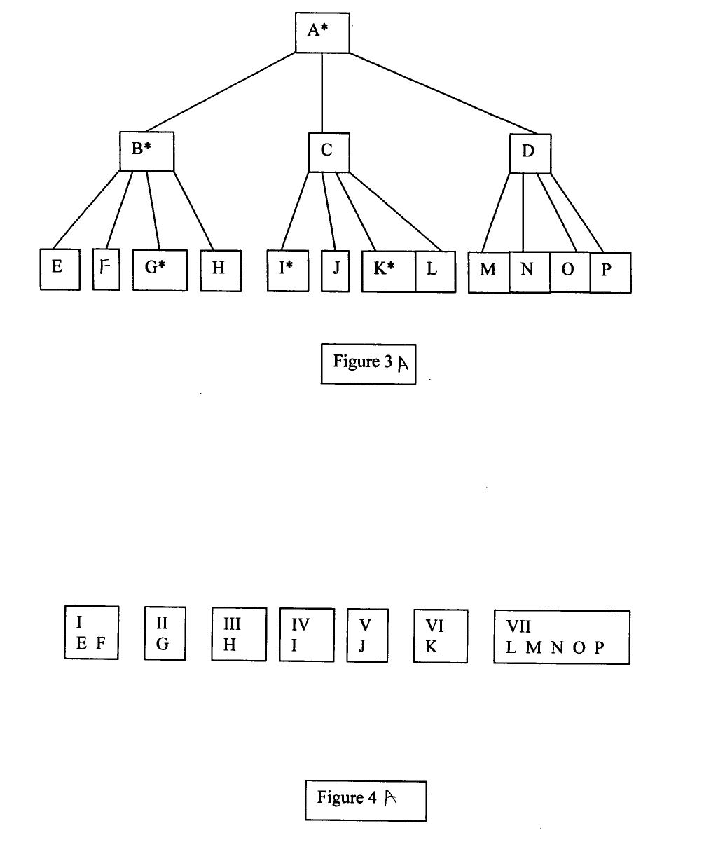

This invention operates in a context in which there is given a hierarchical format specification, e.g. in the form of a tree with some nodes (A, B, G, I, and K) marked as repeating nodes, as shown by the asterisks in FIGS. 3A and 3B. More specifically, FIGS. 3A and 3B illustrate a root node A, branch nodes B, C, D and leaf nodes E-P. Before processing the actual data, the invention first partitions the hierarchical data structure in the DTD file into sections (shown in FIGS. 4A and 4B). FIG. 3A is a reordered tree and illustrates the different partitioning that will occur with different trees as shown in FIGS. 4A and 4B.

The partitioning process is based on the hierarchical data structure (e.g., the DTD file), which is separate from, and different than the hierarchical data file (e.g., the markup language data file). The hierarchical data structures shown in FIGS. 3A and 3B is the hierarchical data structure of markup language files, not the data itself. The hierarchical data structures include repeating nodes A, B, G, I, and K, indicated by the ‘*’ symbol. A distinct section in FIGS. 4A and 4B is exclusively dedicated to each maximally contiguous (on the frontier) set of leaf nodes with the same pattern of repeating nodes occurring on the path from root to leaf.

More specifically, FIGS. 4A and 4B illustrate the results of the partitioning process of the invention on the frontier of the hierarchical data structures of FIGS. 3A and 3B. The partitioning process places a partition boundary at each end of the scope on the frontier of each repeating node. As shown in FIGS. 3A and 4A, the scope of the repeating root A is the entire frontier so boundaries are placed at both ends. (These boundaries are optional because they do not separate any frontier nodes.) The scope of repeating branch node B is the set of nodes from E to H, so boundaries are placed at the end to the left of E and between H and I. The scope of repeating leaf node G is just the node G so boundaries are placed between F and G and between G and H. Likewise the scope of repeating node I is node I and the scope of repeating node K is node K, so boundaries are placed between H and I, between I and J, between J and K, and between K and L. FIGS. 3B and 4B illustrate that the invention first places boundaries before M and after G. Boundaries are also placed before and after repeating I and K nodes. Similarly, repeating node G is provided its own section with additional boundaries. Adjacent boundaries are replaced by one boundary, producing the sections of FIGS. 4A and 4B. Once these sections have been created, the process of partitioning the hierarchical data structure is completed and the parsing process of transferring the data to these sections can begin.

Thus, after completing the partitioning, the invention then parses the actual data contained in the hierarchical data file to produce a stream of data pairs and end of section indicators. The parsing process relocates the position of all data in the hierarchical data structure to the leaf nodes of the hierarchical data structure. Each of the data pairs is in the form (tag, field). The “field” represents node data and the “tag” represents the location of corresponding node data within the hierarchical data structure.

During the data parsing process, the invention loads the fields of the (tag, field) data pairs into corresponding “sections” (created prior to the parsing process) as the data pairs are output from the parsing process. The invention also transfers the fields from these sections to the columns and rows of the relational database structure. Node data is transferred from the sections to the relational database as soon as the loading of a corresponding data pair into a corresponding section is complete, as indicated by the end of section indicators. The data in a section is erased only when, after an end of section indicator is encountered for the section, a new corresponding data pair is produced by the parsing process and is ready to be loaded into such section. This preserves data for as long as possible for use with subsequent sections to capture hierarchical relationships.

Thus, the invention processes a (possibly unending) stream of data organized to conform to the given section structure in order to produce a corresponding sequence of inserts and updates to a relational database. The invention minimizes the required intermediate storage requirement while maximizing the throughput of the processing.

The stream of data being shredded is assumed to carry two types of information: (1) a data value captured as a field, and (2) a relationship position in the tree relative to the other nodes captured as a tag. The names of nodes are unique (or uniqueness may be accomplished by hashing the path (sequence of names) from root to node or by appending distinct numerals to the distinct occurrences of each given name). Note that nodes can be “repeating nodes”; but such nodes themselves do not repeat in the hierarchical data structure (tree for simplicity). The word “repeating” refers to repetitions in a document or data stream that conforms to the tree.

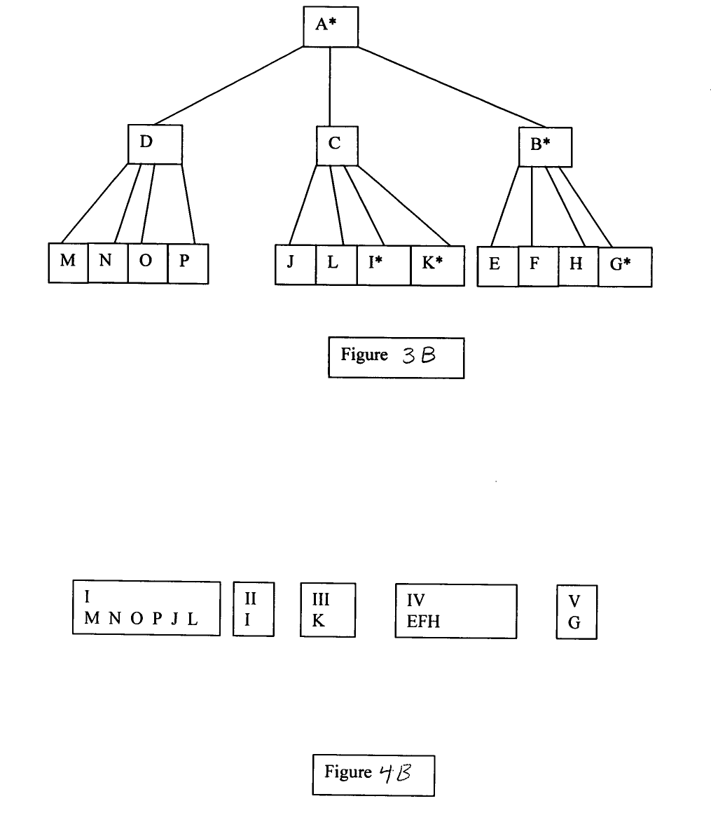

FIG. 5 is a more simplified hierarchical tree and is used to demonstrate the manner in which the invention shreds the data and in the markup language file. This processing is shown in the following example. In this example XML document, the data between <B> and </B> forms the first section. There is a subsequent section for the data between each repetition of <D> and </D>. Then there is a section between each repetition of <E> and </E>, consisting of the data between <G> and <G>, between <H> and </H> and between <I> and </1>. Finally there is one section between −<J> and </J>. Thus, an XML stream conforming to the tree shown in FIG. 5 is as:
<A><B><C>1</C><D>2</D><D>3</D></B><E><F>4</F><G>5</G></E></A><A><E><F>6</F></E></A><A> . . .

Note that any node may be skipped; but, otherwise, this is the XML notion of conforming. The target database schema may be given or the invention may use a relational schema that captures all the information corresponding to the given tree form. If the target database schema is given, then a mapping between the leaf nodes of the tree form and fields of the relational schema must be supplied.

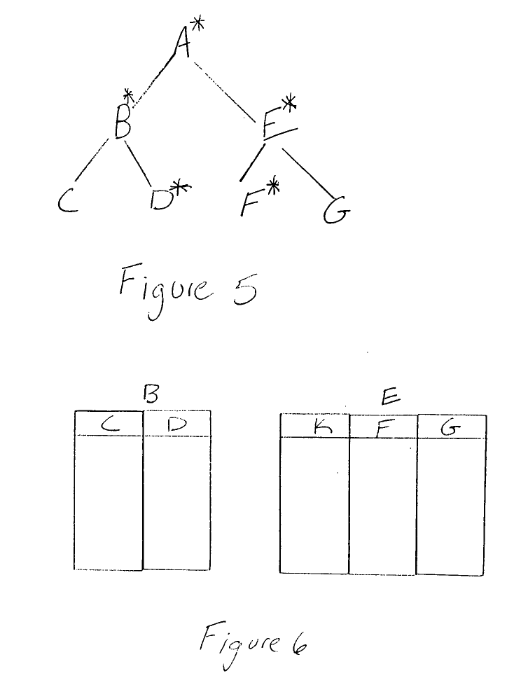

To systematically capture all the information, the invention creates a table in the relational database for each node of the tree, with each table containing a key column and a foreign key column for each child node. The key column for a leaf contains the data values for that leaf. However, much of the information would be redundant. A more typical example of a relational schema corresponding to this example has two tables (B and E shown in FIG. 6). Table B has columns C and D while table E has columns K, F, and G. The information about the relationship among nodes A, B, and E is ignored because these nodes do not contain any data, in that all data has been relocated to the leaf nodes C, D, F, and G. The mapping in this example would be the straightforward mapping of tree nodes C, D, F, and G to columns C, D, F, and G, respectively, with K being a key representing the occurrences of E (in the data stream). In any case, the mapping is assumed given and specified as a set of rules of the form (a) leaf node--> database column, or (b) parent node--> database columns (which are unique keys representing occurrences of the parent node in the data stream). Often, when there is no need to capture the hierarchical relationships between data elements, there will be no rules of type (b).

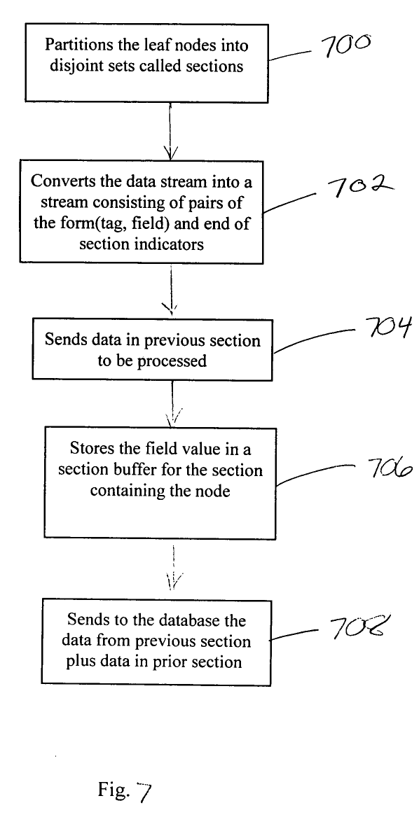

The following assumes that there are no parent nodes that form database columns (e.g., that there are no rules of type (b)). In step 700 in FIG. 7, the invention partitions the leaf nodes into disjoint sets called sections. Each repeating leaf is partitioned into a section by itself. Two non-repeating leaf nodes can be in the same section only if the two nodes and each leaf node between them (on the frontier) have the same set of repeating ancestors. Step 700 is a preprocessing step that is performed before actually beginning to process the data stream. Each section is associated with a buffer data structure with room for one data element corresponding to each node in the section. The sections are ordered in the order encountered on the frontier of the tree.

In step 702, the invention converts the data stream into a stream of pairs of the form (tag, field) and “end of section” indicators. The value of the tag represents a unique leaf node in a tree. The value of the tag may be a data element from the stream, the name of an XML tag in the stream, an encoding of a path in a tree with repeating nodes, or a data element that appears between two XML tags in the data stream (see the “rotation” method below). The value of the field is a data element from the stream or may be a data element that appears between two XML tags in the data stream when the data stream is an XML data stream.

A SAX parser (available from Sun Microsystems, Sunnyvale, Calif., USA) may be used to parse the data as part of step 702. End of section indicators are produced when the end of a repeating section in the data stream is encountered or when a new section is encountered for XML. The end of section indicator is produced when the begin tag of a repeating element is encountered or when the end tag of a repeating element is encountered, except that at most one end of section indicator is produced between (tag, field) pairs.

In step 704, when an “end of section” indicator is encountered, the invention sends the data in the previous section buffer to be processed (as explained below with respect to step 708) and erases data in the new section buffer. In step 706, for each (tag, field) pair produced by step 702, the invention stores the field value in a section buffer for the section containing the node represented by the tag value. In step 708, the invention sends to the database (as an SQL instruction) the data in the previous section (see step 704) plus data in any other prior (in frontier order) section that maps to the same table as some node in the previous section.

If the DTD is ordered so that non-repeating nodes (with no repeating descendants) precede other nodes at every level of the tree, then no rules of type (b) are required to capture all the relationship information provided by a conforming document. Thus, in a preferred embodiment, the invention reorders the DTDs to satisfy this requirement whenever possible.

This reordering method can only be practiced when the practitioner controls the generation of the hierarchical data (stream) and can make it conform to the reordered structure. Reordering begins at the lowest non-leaf level of the tree. Non-repeating children (leaves) are moved in front of repeating leaves. Reordering proceeds iteratively up the tree toward the root. At each level, non-repeating children with no repeating descendents are moved in front of all other children. The result of applying reordering to the tree in FIGS. 3A and 3B is the tree in FIGS. 3A and 3B. The result of applying partitioning to the tree in FIGS. 3A and 3B is the set of sections in FIGS. 4A and 4B. Notice that the number of sections, and therefore the number of SQL statements to execute, is reduced from 7 in FIGS. 4A and 4B to FIGS. 4A and 4B.

Therefore, the invention provides a method of altering the hierarchical structure of a markup language file for being processed into a relational database. This methodology identifies repeating nodes and non-repeating nodes within the hierarchical structure and reorganizing the hierarchical structure such that non-repeating nodes are positioned before repeating nodes within each hierarchal level of the hierarchical structure (as shown by comparing FIGS. 3A and 3B). The hierarchical structure can comprises a tree structure having root node(s), branch node(s) proceeding from the root nodes, and leaf node(s) proceeding from the branch nodes. The process of reorganizing the hierarchical structure first reorganizes the root nodes such that non-repeating root nodes are positioned before repeating root nodes. Then, after reorganizing the root nodes, the invention reorganizes branch nodes such that non-repeating branch nodes are positioned before repeating branch nodes. Lastly, after reorganizing the branch nodes, this methodology reorganizes the leaf nodes such that non-repeating leaf nodes are positioned before repeating leaf nodes.

If a tree has a node that violates the precedence requirement above, then its parent (immediate ancestor in the tree) will be called a node of type (b) and must have a rule of type (b) to preserve the relationship information. A node of type (b) must appear in each section containing one of its descendents. Each time the begin tag corresponding to such a node appears in the document data stream, a unique key is generated and inserted into the corresponding buffer for each section containing a descendent.

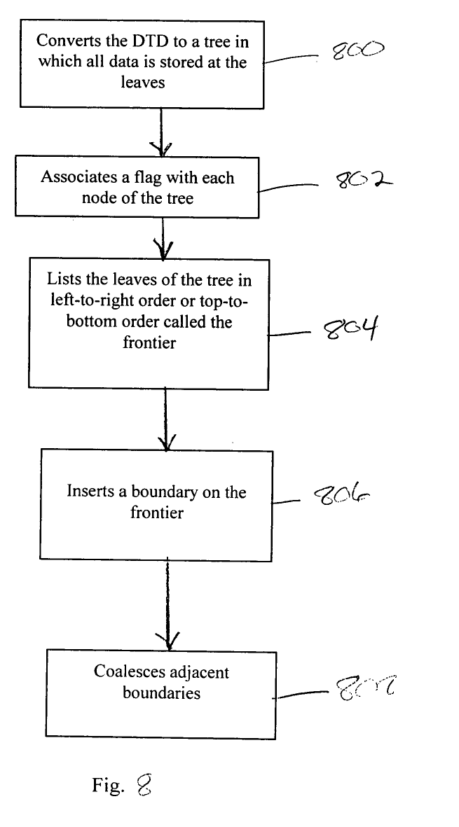

The detail of the processing that divides the XML document into contiguous sections is shown in FIG. 8. First, in item 800, the invention converts the DTD to a tree in which all data is stored at the leaves. In item 802, a flag is associated with each node of the tree. The flags indicate whether it is repeating (* or + operators in XML). Then, in item 804, the invention lists the leaves of the tree in depth first search order. This listing is called the frontier. In item 806, for each repeating node, the invention inserts a boundary on the frontier before the first leaf node in its scope and after the last leaf node in its scope. The scope of a node is the set of its descendants on the frontier. In item 808, the invention coalesces adjacent boundaries. The resulting boundaries determine the boundaries between contiguous sections of an XML document that satisfies the DTD.

Two dimensional rotation is a transformation of an XML repeating group specified by DTD statements of the form:
<!ELEMENT GROUP (NAME,VALUE)>
<!ELEMENT NAME (PCDATA)>
<!ELEMENT VALUE (PCDATA)>
   into a set of leaf tags with data.

The method works independently on each instance of the group, transforming <GROUP><NAME>data1</NAME><VALUE>data2<VALUE.</GROUP> into <data1>data2</data1>.

In its multidimensional (>2) form, the method transforms a group GROUP with n children V1, . . . . Vn into a hierarchical nesting with n levels: <GROUP><V1>d1</V1><V2>d2<V2> . . . <Vn−1>dn−1</Vn−1><Vn>dn</Vn></GROUP>, is transformed into <d1><d2> . . . <dn−1>dn</d2></d1>.

The first step is to parse the XML document with a SAX parser or simple substring method that produces relevant XML events in a stream. If there are attributes, the invention converts the attributes into elements. If there are generic parameter tags with name and value child tags, the invention converts the value of the name tag to a new tag and the value of the value tag to the value of the new tag. The result of the preprocessing sends to the next stage a sequence of (tag, data) pairs where the tag carries sufficient information to uniquely identify its place in the DTD. The invention works on DTDs for which these preprocessing techniques produce a stream of (tag, data) pairs in which each data element corresponds to one specific column in one specific table of the target relational database. However, if an element (column entry) in the database is a function of multiple hierarchically related XML element values, then, because of the choice of when to erase buffers, the function may be performed when the last of the multiple XML values appears. Aggregate functions cannot be performed in this way and must be performed after the data is entered into the database.

There are sets of “rules” governing how XML data is handled by the normalizer. A first set of rules is called the state machine. As the parser sequentially processes an XML input file, it sends both state updates (i.e., I am now in a “SanXml” section) as well as data (SanXml.Name, [WWN]) to the state machine. Using this information, the state machine maintains awareness of the context of all data it is receiving. Upon receiving data, the state machine consults a rule set specific to the DTD of this XML file, which specifies how to map XML input data into the memory “buffers” that temporarily store it. An example rule is: “SanXml”,“SanXml.Name”,“SanXml”, “WWN”, (some other data), meaning (left to right). When the state machine is in a “SanXml” section and it gets data for a “SanXml.Name” tag. That data is placed into the “SanXml” buffer under the column “WWN”. Additional information may be supplied when defining the rule that tells the state machine to do other things as well. This rule is referred to as a “data map” rule.

Another example, which defines a relationship rule: “SanXml”,“SanXml.FcPortldXml”,“PORT2SAN”,“PortWWN”,“SanXml”,“WWN”,“SanWWN”, “FcPortXml”,“WWN”, means when the state machine is in a “SanXml” section and it gets data for “SanXml.FcPortldXml” (i.e., the WWN of a Pod the SAN contains), it places that data into the “PORT2SAN” buffer under the column “PortWWN”; Since SanXml is the parent of this FcPort. The rule continues thus: take the data already placed in buffer “SanXml”, column “WWN” (the WWN of this SAN), this data is placed in the “PORT2SAN” buffer, column “SanWWN”. Because this type of rule is defined as a Parent-Child relationship, the state machine then calls on the “PORT2SAN” buffer class to generate insert & update SQL and immediately sends this off to the DATABASE for transaction. Finally, the last part of the rule (which is optional) tells the state machine to also put the value for the child (FcPortIdXml) into the “FcPortXml” buffer, column “WWN” and then likewise send an insert/update SQL query to the DATABASE.

The above rules cover both data and relationships mapping from XML input to memory buffers. The memory buffers themselves are pre-programmed with specifications on the columns they contain, what type of data is in those columns, etc. These rules govern the mapping between the memory buffers and the generation of the final insert & update SQL. These rules—which are universal to all XML input files regardless of DTD (assuming that the same DATABASE schema is used for storing all XML input) are loaded once (globally) among all processor threads. An example rule follows: “SanXml”,“SAN”,“SanXml.Nam&,“WWN”,“CHAR”, 16, (other parameters), which means create a buffer called “SanXml” that maps to the “SAN” table in the DATABASE. When data with a tag “SanXml.Name” is encountered, this rule places that in a column in the buffer called “WWN”. This column is of type “CHAR” (so quotes will be put around it when the SQL is generated), with a maximum length of 16 (i.e. if it's longer, then it will be truncated when the SQL is generated). Other parameters may include specifying another DATABASE table and column for looking up auto-generated integer IDs when inserting, for example, Vendor information. Vendor information comes in as text, but must be converted to an integer number which is a FK to the TSRM_VENDOR table. So an example of this could be: “FcPortXml”,“PORT”,“FcPortXml.Vendor”,“VENDOR”,“AUTOGEN”, 0, “TSRM_VENDOR”, “NAME”.“ID”, which means when generating the SQL,“ALJTQGEN” will signify: add a select block into the SQL that looks up TSRM_VENDOR.NAME=VENDOR, and then uses TSRM_VENDORJD (the DATABASE auto-generated integer) as the value of PORT.VENDOR when writing to the DATABASE. Again, all this is automatic, but the data type “AUTOGEN” tells the pre-processor how to write the necessary SQL to handle this behavior. One advantage of having two separate rule sets (one for XML-> buffer mapping and one for buffer-> DATABASE schema mapping) is that the latter rule set is universal. This helps with future maintainability, so that DATABASE schema is not tangled up with XML handling rules.

Using a DOM parser, a complete parse tree for an XML document can be built, and then classes corresponding to each target database table can be defined. Each class then is given a method to extract data for itself from the parse tree. Finally, supervisory code calls these extraction methods in an appropriate order to load the database. This approach works well when the data is contained in a physically realized parse tree, so the memory requirement grows with the size of the document. Also, the parse is completed first before any other processing is started.

Therefore, unlike conventional systems that vary memory size with the size of the markup language data file, the memory requirements with the invention are limited to the size of the hierarchical tree within the DTD file. Thus, once the sections are created corresponding to the DTD hierarchical structure, endless amounts of data (e.g., endless data stream) can be processed through the sections into the relational database tables. Thus, with the invention, the size of the markup language data file is irrelevant and the only size of concern is the DTD file. Therefore, the invention substantially reduces memory requirements when compared to conventional systems. Further, the invention speeds processing because, once the sections are created, data is transferred to the relational database tables as soon as the data being written to a given section is complete (e.g., when an end of section indicator is encountered war the beginning of a different section is indicated). Thus, the invention is substantially superior to conventional systems that shred markup language data into relational database tables.

It should be understood, however, that the foregoing description, while indicating preferred embodiments of the present invention and numerous specific details thereof, is given by way of illustration and not of limitation. Many changes and modifications may be made within the scope of the present invention without departing from the spirit thereof, and the invention includes all such modifications. For example, extensible markup language (XML) is only one example of a hierarchical organizing format for data. The invention would apply equally to any other hierarchical format that can be expressed via a tree structure with certain nodes marked as repeating nodes.

Advantages of practicing the invention include the ability to process a potentially unending stream with memory requirements determined by the data structure rather than the size of the file, a reduction in the number and complexity of SQL statements that must be executed to move the data into a relational database, and a simplification of the structure of the database required to capture all information carried by the file. The methods of the invention can be used to map any hierarchically organized data into tables or into other data structures, since the sections provide a convenient intermediate form. In particular, these methods could be used to convert a hierarchical database (e.g. an IMS database) into a relational database.

While the invention has been described in terms of preferred embodiments, those skilled in the art will recognize that the invention can be practiced with modification within the spirit and scope of the appended claims.

1. A method of transferring data from a markup language file having a hierarchical structure to a relational database, said hierarchical structure comprising a tree or forest of nodes on which depth first search imposes a total ordering, with some nodes designated as repeating nodes, and said method comprising:
partitioning said hierarchical structure into sections, wherein each section is dedicated to at least one leaf node of said hierarchical structure, and wherein two non-repeating leaf nodes that are adjacent in frontier order and have the same parent are contained in the same section, frontier order being the order in which leaf nodes are encountered in a depth first search of said hierarchical structure;
allocating a memory section for each of said sections of said hierarchical structure according to the data types of the nodes in the section;
after completing said partitioning and allocating, parsing said markup language file to produce a stream of data pairs, wherein each of said data pairs comprises an element of node data and an element of node location information, and wherein said node location information indicates the location of the corresponding node within said hierarchical structure;
while performing said parsing process, loading said node data into the memory section allocated for the section containing the corresponding node location as said data pairs are output from said parsing process; and
transferring said node data from said sections to said relational database, wherein information is transferred from one section as soon as said loading process completes loading at least one element of node data to said one memory section and an end of section indicator has been encountered by said parsing process.

2. The method in claim 1, wherein said partitioning said hierarchical structure into sections, wherein each section is dedicated to at least one leaf node of said hierarchical structure, and wherein two non-repeating leaf nodes that are adjacent in frontier order and have the same parent are contained in the same section, frontier order being the order in which leaf nodes are encountered in a depth first search of said hierarchical structure.

3. The method in claim 1, further comprising erasing said memory section, wherein a first memory section is erased only when an end of section indicator has been encountered by said parsing process, a new corresponding data pair is produced by said parsing process, and the node data of said data pair is ready to be loaded in said first memory section.

4. The method in claim 1, wherein said transferring said node data from said sections to said relational database, wherein information is transferred from one section as soon as said loading process completes loading at least one element of node data to said one memory section and an end of section indicator has been encountered by said parsing process, wherein an end of section indicator is encountered when the parsing process produces either a node location from a different section or a node location at or preceding the last of the at least one node location in the one section in depth first search order.

5. The method in claim 1, wherein said node location information of said data pairs comprises leaf nodes of said hierarchical data structure.

6. The method in claim 1, wherein in said partitioning process any two non-repeating leaf nodes of said hierarchical structure that are adjacent in frontier order and have the same repeating ancestors are in the same section.

7. The method in claim 1, wherein said parsing process relocates all data in said hierarchical structure to the leaf nodes of said hierarchical structure.

8. A method of transferring data from a markup language file having a hierarchical structure to a relational database, said hierarchical structure comprising a tree or forest of nodes on which depth first search imposes a total ordering, with some nodes designated as repeating nodes, and said method comprising:
partitioning said hierarchical structure into sections, wherein each section is dedicated to at least one leaf node of said hierarchical structure, and wherein two non-repeating leaf nodes that are adjacent in frontier order and have the same parent are contained in the same section, frontier order being the order in which leaf nodes are encountered in a depth first search of said hierarchical structure;
allocating a memory section for each said section of said hierarchical structure according to the data types of the nodes in the section;
after completing said partitioning and allocating, parsing said markup language file to produce a stream of data pairs, wherein each of said data pairs comprises an element of node data and an element of node location information, and wherein said node location information indicates the location of the corresponding node within said hierarchical structure;
loading said node data into corresponding sections as said node data elements are output from said parsing process; and
transferring said node data from said sections to said relational database, wherein information is transferred from one section as soon as said loading process completes loading at least one element of node data to said one memory section and an end of section indicator has been encountered by said parsing process.

9. The method in claim 8, wherein said partitioning said hierarchical structure into sections, wherein each section is dedicated to at least one leaf node of said hierarchical structure, and wherein two non-repeating leaf nodes that are adjacent in frontier order and have the same parent are contained in the same section, frontier order being the order in which leaf nodes are encountered in a depth first search of said hierarchical structure.

10. The method in claim 8, further comprising erasing said memory section, wherein a first memory section is erased only when an end of section indicator has been encountered by said parsing process, a new corresponding data pair is produced by said parsing process, and the node data of said data pair is ready to be loaded in said first memory section.

11. The method in claim 8, wherein said transferring said node data from said sections to said relational database, wherein information is transferred from one section as soon as said loading process completes loading at least one element of node data to said one memory section and an end of section indicator has been encountered by said parsing process, wherein an end of section indicator is encountered when the parsing process produces either a node location from a different section or a node location at or preceding the last of the at least one node location in the one section in depth first search order.

12. The method in claim 8, wherein said node location information of said data pairs comprises leaf nodes of said hierarchical data structure.

13. The method in claim 8, wherein in said partitioning process any two non-repeating leaf nodes of said hierarchical structure that are adjacent in frontier order and have the same repeating ancestors are in the same section.

14. The method in claim 8, wherein said parsing process relocates all data in said hierarchical structure to the leaf nodes of said hierarchical structure.

15. A method of transferring data from a markup language file having a hierarchical structure to a relational database, said hierarchical structure comprising a tree or forest of nodes on which depth first search imposes a total ordering, with some nodes designated as repeating nodes, and said method comprising:
partitioning said hierarchical structure into sections, wherein each section is dedicated to at least one leaf node of said hierarchical structure, and wherein two non-repeating leaf nodes that are adjacent in frontier order and have the same parent are contained in the same section, frontier order being the order in which leaf nodes are encountered in a depth first search of said hierarchical structure;
allocating a memory section for each said section of said hierarchical structure according to the data types of the nodes in the section;
after completing said partitioning and allocating, parsing said markup language file to produce a stream of data pairs, wherein each of said data pairs comprises an element of node data and an element of node location information, and wherein said node location information indicates the location of the corresponding node within said hierarchical structure;, wherein each of said data pairs is in the form (tag, field), and wherein said field represents node data and said tag represents the location of corresponding node data within said hierarchical structure;
loading said data pairs into corresponding sections as said data pairs are output from said parsing process; and
transferring said node data from said sections to said relational database, wherein information is transferred from one section as soon as said loading process completes loading at least one element of node data to said one memory section and begins loading a different element of node data to a different memory section.

16. The method in claim 15, wherein said partitioning is based on a document type definition file, separate from said hierarchical file, wherein said document type definition file comprises said hierarchical structure.

17. The method in claim 15, further comprising erasing said sections, wherein a first section is erased only when a new corresponding data pair is produced by said parsing process and is ready to be loaded in said first section.

18. The method in claim 15, wherein said transferring process is performed as soon as the loading of a corresponding data pair into a corresponding section is complete, as indicated by said end of section indicators.

19. The method in claim 15, wherein said data pairs comprise leaf nodes of said hierarchical structure.

20. The method in claim 15, wherein leaf nodes of said hierarchical structure include repeating nodes and wherein a different section is exclusively dedicated to each of said repeating nodes.

21. The method in claim 15, wherein said parsing process relocates all data in said hierarchical structure to the leaf nodes of said hierarchical structure.

22. A method of altering the hierarchical structure of a markup language file for being processed into a relational database, said method comprising:
identifying repeating nodes and non-repeating nodes within said hierarchical structure; and
reorganizing said hierarchical structure such that non-repeating nodes are positioned before repeating nodes within each hierarchal level of said hierarchical structure.

23. The method in claim 22, wherein said hierarchical structure comprises the tree structure having at least one root node, at least one branch node proceeding from said root node, and least one leaf node proceeding from said branch node.

24. The method in claim 23, wherein said process of reorganizing said hierarchical structure comprises:
reorganizing root nodes such that non-repeating root nodes are positioned before repeating root nodes;
after reorganizing said root nodes, reorganizing branch nodes such that non-repeating branch nodes are positioned before repeating branch nodes; and
after reorganizing said branch nodes, reorganizing leaf nodes such that non-repeating leaf nodes are positioned before repeating leaf nodes.

25. The method in claim 22, wherein said hierarchical structures is contained within a document type definition (DTD) file.

26. A method of transferring data from a markup language file having a hierarchical structure to a relational database said method comprising:
partitioning said hierarchical structure into sections;
allocating a memory section for each of said sections of said hierarchical structure according to the data types of the nodes in the section;
after completing said partitioning and allocating, parsing said markup language file to produce a stream of data pairs while performing said parsing process, loading said node data into the memory section allocated for the section containing the corresponding node location as said data pairs are output from said parsing process; and
transferring said node data from said sections to said relational database.

27. A program storage device readable by machine, tangibly embodying a program of instructions executable by the machine to perform a method of transferring data from a markup language file having a hierarchical structure to a relational database, said hierarchical structure comprising a tree or forest of nodes on which depth first search imposes a total ordering, with some nodes designated as repeating nodes, and said method comprising:
partitioning said hierarchical structure into sections, wherein each section is dedicated to at least one leaf node of said hierarchical structure, and wherein two non-repeating leaf nodes that are adjacent in frontier order and have the same parent are contained in the same section, frontier order being the order in which leaf nodes are encountered in a depth first search of said hierarchical structure;
allocating a memory section for each said section of said hierarchical structure according to the data types of the nodes in the section;
after completing said partitioning and allocating, parsing said markup language file to produce a stream of data pairs, wherein each of said data pairs comprises an element of node data and an element of node location information, and wherein said node location information indicates the location of the corresponding node within said hierarchical structure;
while performing said parsing process, loading said node data into the memory section allocated for the section containing the corresponding node location as said data pairs are output from said parsing process; and
transferring said node data from said sections to said relational database, wherein information is transferred from one section as soon as said loading process completes loading at least one element of node data to said one memory section and begins loading a different element of node data to a different memory section.

28. The program storage device in claim 27, wherein said method further comprises partitioning said hierarchical structure into sections, wherein each section is dedicated to at least one leaf node of said hierarchical structure, and wherein two non-repeating leaf nodes that are adjacent in frontier order and have the same parent are contained in the same section, frontier order being the order in which leaf nodes are encountered in a depth first search of said hierarchical structure.

29. The program storage device in claim 27, wherein said method further erasing said memory section, wherein a first memory section is erased only when an end of section indicator has been encountered by said parsing process, a new corresponding data pair is produced by said parsing process, and the node data of said data pair is ready to be loaded in said first memory section.

30. The program storage device in claim 27, wherein said method further comprises transferring said node data from said sections to said relational database, wherein information is transferred from one section as soon as said loading process completes loading at least one element of node data to said one memory section and begins loading a different element of node data to a different memory section.

31. The program storage device in claim 27, wherein said method further comprises node location information of said data pairs comprise leaf nodes of said hierarchical data structure.

32. The program storage device in claim 27, wherein said method further comprises partitioning process any two non-repeating leaf nodes of said hierarchical structure that are adjacent in frontier order and have the same repeating ancestors are in the same section.

33. The program storage device in claim 27, wherein said method further comprises parsing process relocates all data in said hierarchical structure to the leaf nodes of said hierarchical structure.
